(19) United States
(12) Patent Application Publication
(10) Pub. No.: US 2021/0155539 A1
(43) Pub. Date: May 27, 2021

(54) GLASS PRODUCT, METHOD FOR PREPARING GLASS PRODUCT, AND GLASS PRODUCT PREPARATION APPARATUS

(71) Applicant: SHENZHENSHI YUZHAN PRECISION TECHNOLOGY CO., LTD., Shenzhen (CN)

(72) Inventors: CHEN-YU HONG, New Taipei (TW); BING-JIE GE, Shenzhen (CN); CAN TANG, Shenzhen (CN); CHIN-HSIEN HUANG, New Taipei (TW)

(21) Appl. No.: 17/033,839

(22) Filed: Sep. 27, 2020

(30) Foreign Application Priority Data
Nov. 27, 2019 (CN) 201911185831.X

(51) Int. Cl. C03C 23/00; B23K 26/53; B23K 26/06; B23K 26/0622; B23K 26/08

(52) U.S. Cl. CPC C03C 23/0025; B23K 26/53; B23K 26/0665; B23K 2103/54; B23K 26/08; B23K 26/0648; B23K 26/0622

(57) ABSTRACT

A glass product includes a glass substrate and first protrusion. The first protrusion is provided on the glass substrate and is with a first atom-aggregation state. The glass substrate is with a second atom-aggregation state. The first atom-aggregation state is different from the second atom-aggregation state. The present application also proposes a method for preparing the glass product and an apparatus for preparing the glass product. The glass product is irradiated with a ultra-short pulse laser on the surface of the glass substrate, so that bonds between atoms on the surface of the glass substrate are broken, thereby changing the arrangement of the atoms, and light is diffusely reflected when irradiating the surface of the glass product.

This disclosure claims priority to Chinese Patent Disclosure No. 201911185831.X filed on Nov. 27, 2019, the contents of which are incorporated by reference herein.

### FIELD

The present application relates to a glass product, a method for preparing the glass product, and a glass product preparation apparatus.

### BACKGROUND

With the advancement of technology, 3C products have gradually become indispensable consumer products in people's daily lives. The manufacturers of 3C products have further requirements on product quality and appearance. Matte glass products are introduced into 3C products gradually. The matte glass product is one kind of glass product; the glass product is processed so that the surface of the glass product produces diffuse reflection after being irradiated by light. The appearance of matte glass products is like a layer of fog setting on the glass surface, which is very popular with consumers due to the unique visual effect. However, it is difficult to obtain glass products of consistent quality. There is no preparation method satisfying both the environmental protection requirements and easing operation.

### SUMMARY OF THE INVENTION

In view of the above situation, it is necessary to provide a glass product, a method for preparing the glass product, and a glass product preparation apparatus to solve at least one of the above problems.

A glass product includes a glass substrate and a first protrusion and the first protrusion is provided on the glass substrate, the first protrusion is with a first atom-aggregation state, the glass substrate is with a second atom-aggregation state, and the first atom-aggregation state and the second atom-aggregation state are different.

A method for preparing a glass product includes fixing a glass substrate; adjusting a focus depth of a laser, the focus depth includes a first focus depth and a second focus depth, and the laser is a pulse laser; setting fogging parameters of the laser; and scanning and irradiating the glass substrate with the pulse laser between the first focus depth and the second focus depth according to the fogging parameters, and to break atomic bonds on the surface of the glass substrate. A first protrusion is formed on the glass substrate. The first protrusion is with a first atom-aggregation state, and the glass substrate is with a second atom-aggregation state. The first atom-aggregation state is different from the second atom-aggregation state, thereby forming the glass product.

A glass product preparation apparatus includes a laser device; and a fixing device for fixing a glass substrate.

The laser device is used to emit a pulse laser, and to adjust a focus depth. The focus depth includes a first focus depth and a second focus depth. Setting fogging parameters of the pulse laser is for scanning and irradiating the glass substrate between the first focus depth and the second focus depth. A first protrusion is formed on the glass substrate. The first protrusion is with a first atom-aggregation state, the glass substrate is with a second atom-aggregation state, and the first atom-aggregation state is different from the second atom-aggregation state, thereby forming a glass product.

The glass product provided by the present application, the method for preparing the glass product, and the glass product preparation apparatus irradiate the surface of the glass substrate with an ultra-short pulse to break the bonds between the atoms on the surface of the glass substrate, thereby changing the arrangement of the atoms to form a glass product. Light diffusely reflects on the surface of the glass product, showing a fogging effect. By using the method, the process of fogging is rapid, and does not need to contact the glass directly or chemically etch the glass during the production process, which reduces the cost and is with no pollution.

### BRIEF DESCRIPTION OF THE DRAWINGS

FIG. 1 is a perspective schematic view of a glass product preparation apparatus in some embodiments of the present application.

FIG. 2 is a flowchart of a method for preparing a glass product in some embodiments of the present application.

FIG. 3 is a photograph of the glass product.

FIG. 4 is a microscope photograph of the glass product.

FIG. 5 is a schematic diagram of the glass product in some embodiments of the present application.

The following specific embodiments will further describe the present application with reference to the above drawings.

### DETAILED DESCRIPTION

The technical solutions in the embodiments of the present application will be described clearly and completely below with reference to the drawings in the embodiments of the present application. Obviously, the described embodiments are only a part of the embodiments of the present application, but not all the embodiments. Based on the embodiments in this application, all other embodiments obtained by a person of ordinary skill in the art without creative work fall within the protection scope of this application.

It should be noted that when an element is considered to be “connected” to another element, it may be directly connected to another element or there may be an element that is centrally located at the same time. When an element is considered to be “disposed” on another element, it may be directly arranged on the other element or there may be a centrally arranged element at the same time.

Unless otherwise defined, all technical and scientific terms used herein have the same meaning as commonly understood by those skilled in the technical field of the present application. The terminology used in the specification of the present application herein is for the purpose of describing specific embodiments only, and is not intended to limit the present application. The term “and/or” as used herein includes any and all combinations of one or more related listed items.

In the related art, glass fogging methods include grinding, chemical etching, and sandblasting. The method of grinding is using a grinding wheel to grind the glass. But by the method of grinding, a roughness of the glass is too high, and it is not easy to control an accuracy of the process, resulting in poor hand-feel of the glass. The method of chemical etching generates a lot of smoke and chemical waste during a chemical reacting process between the chemical agent and the glass. The method of sandblasting uses gas to drive sand particles to strongly hit the surface of the glass. But by the method of sandblasting, the roughness of the glass is too high, and many micro-cracks appear on the glass surface, and it is difficult to control a spraying accuracy of the nozzle with high pressure to spray the sand particles, thereby obtaining the glass with uniform roughness.

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

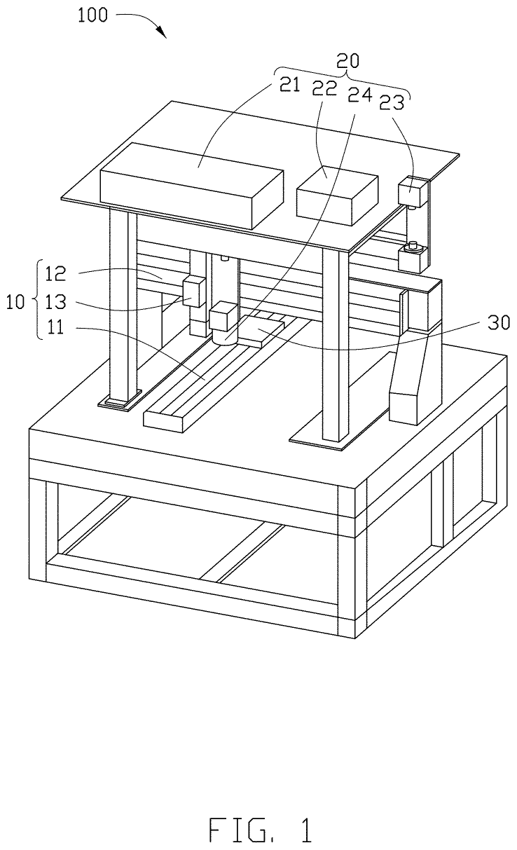

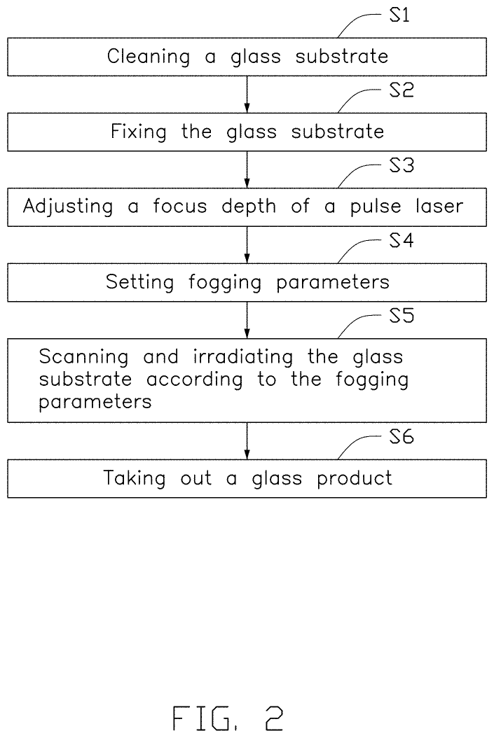

Please refer to FIG. 1 and FIG. 2 at the same time. This application provides a method for preparing a glass product, the glass product is a fogged glass, the method includes the following steps:

In step S1, a glass substrate is cleaned.

Specifically, the glass substrate is provided, and at least one surface of the glass substrate is cleaned.

In some embodiments, the surface of the glass substrate is cleaned by ultrasound. An ultrasonic cleaning machine is provided to clean the glass substrate, the current of the cleaning machine is selected as 2A, the ultrasonic frequency is selected as 80 kHz, the temperature of the cleaning reagent (usually ultrapure water) is set as 50□, and the cleaning time is 10 min.

In step S2, the glass substrate is fixed.

In some embodiments, a glass product preparation apparatus 100 is provided, which includes a moving device 10, a laser device 20, and a fixing device 30. The fixing device 30 is used to fix the glass substrate, and the laser device 20 is used to emit the pulse laser. The moving device 10 is used to adjust a position between the laser device 20 and the glass substrate. The glass substrate is placed in the fixing device 30 and fixed.

In step S3, a focus depth of the pulse laser is adjusted.

Specifically, the moving device 10 includes a first driving member 11, a second driving member 12, and a third driving member 13. The first driving member 11 is used to drive the fixing device 30 to move in a first direction. The second driving member 12 is used to drive the third driving member 13 to move in a second direction. A third direction is the height direction. The first direction, the second direction, and the third direction are perpendicular to each other. The laser device 20 includes a laser head 21, a beam expander 22, a reflector group 23, and a focus unit 24. The laser head 21 is used to provide the pulse laser and set fogging parameters. The beam expander 22 is used to change a diameter and a divergence angle of the pulse laser. The reflector group 23 is used to reflect the pulse laser passing through the beam expander 22 to let the pulse laser enter the focus unit 24. The focus unit 24 focuses the pulse laser. The focus unit 24 is provided on the third driving member 13. The third driving member 13 is used to drive the focus unit 24 to move in the third direction.

The fixing device 30 with the glass substrate is placed on the first driving member 11. The fixing device 30 is driven to move in the first direction by the first driving member 11. The second driving member 12 drives the focus unit 24 setting on the third driving member 13 to move in the second direction, thereby to move the fixing device 30 to be located below the focus unit 24. The distance between the focus unit 24 and the glass substrate on the fixing device 30 is adjusted by the third driving member 13 so that a focus of the pulse laser emitted from the focus unit 24 is focused on the glass substrate. The focus depth includes a first focus depth and a second focus depth.

In step S4, fogging parameters are set.

Specifically, the fogging parameters include the optical energy density, frequency, and scanning speed of the pulse laser. The optical energy density of the pulse laser is greater than or equal to 1*10¹³ W/cm². A range of the frequency of the pulse laser is 80-200 kHz. A range of the scanning speed of the pulse laser is 2000-5000 m/s. In some embodiments, a power of the laser head 21 is set in a range of 15-30 W, and a preferred power is of 19.2 W, and a frequency of the laser head 21 is 100 kHz, so that the optical energy density of the pulse laser focusing on the glass substrate reaches 2*10¹³ W/cm². The laser focus is controlled to move on the glass substrate, and the scanning speed is 3800 m/s.

A slower moving speed of the laser focus and a higher power and frequency of the pulse laser causes a higher degree of fogging. A lower energy of the laser causes a smaller regularity and a smaller fogging pattern.

In step S5, the glass substrate is scanned and irradiated according to the fogging parameters.

Specifically, the laser head 21 is turned on, and the focus unit 24 is driven to move relative to the glass substrate, so that the focus of the pulse laser moves on the glass substrate according to the fogging parameters between the first focus depth and the second focus depth, and the glass substrate is fogged to form the glass product.

The main component of glass is SiO₂, and the microstructure of the glass is amorphous. The internal structure of the atoms in the glass is covalently bonded, and the Si—Si bond energy is about 222 KJ/mol (bond length about 233 pm), and the Si—O bond energy is about 452 KJ/mol (bond length about 163 pm). When an ultra-short pulse laser (femtosecond laser) 0exceeds the bond energy between the atoms, the ultra-short pulse laser can break the covalent bonds between the atoms on the glass surface, so that a smooth glass surface becomes rough due to the destruction of the covalent bonds. When a light irradiates the glass surface, a diffuse reflection is appeared, and showing a fogging effect. The covalent bonds of the inner layer structure of the glass are not broken, and the strength of the glass can be maintained.

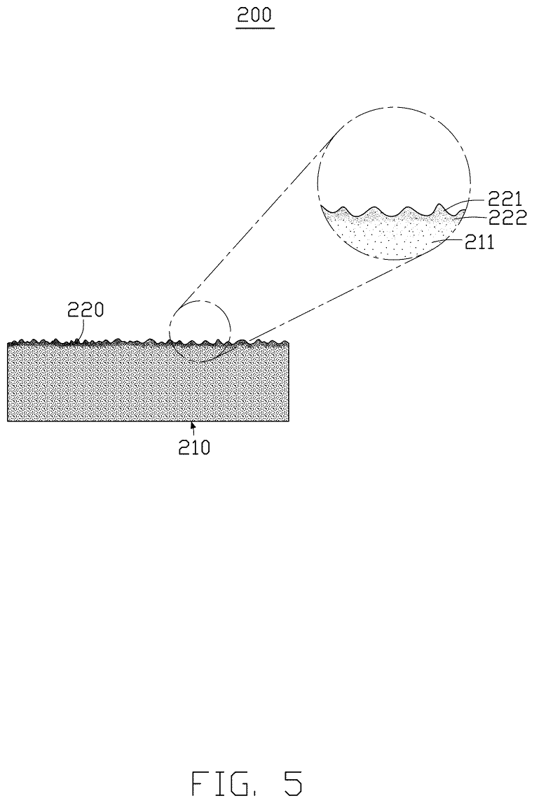

Specifically, referring to FIG. 5, a first protrusion 221 is formed on the glass substrate 211 by breaking the covalent bonds between atoms on a portion of the surface of the glass substrate 211. The formation of the first protrusion 221 makes a fogging effect of the surface of the glass substrate 211. The first protrusion 221 is with a first atom-aggregation state, the glass substrate 211 is with a second atom-aggregation state, and the first atom-aggregation state is different from the second atom-aggregation state, thereby forming the glass product 200. The side of the glass product 200 that is not irradiated by the pulse laser is with a gloss surface 210 same as the ordinary glass, and a fogged surface 220 with the fogging effect is formed on the side irradiated by the pulse laser.

The atom-aggregation state refers to a state formed by the interaction of Si, O, Na, and other atoms in the glass, including the atomic bonding density. The first atom-aggregation includes a first atomic bonding density, and the second atom-aggregation includes a second atomic bonding density. Each of the atoms in the glass is bonded by a covalent bond. The first atomic bonding density is different from the second atomic bonding density. The method of qualitatively characterizing the bonding density of atoms is to use a SEM (i.e. Scanning Electron Microscope) test. In a SEM image of the SEM test, the color of the first protrusion 221 is darker than the color of the glass substrate 211, which represents the bonding density between the atoms in the first protrusion 221 being greater than the bonding density between the atoms in the glass substrate 211. That is the first atomic bonding density being greater than the second atomic bonding density.

A transition region 222 is further formed at the connection between the first protrusion 221 and the glass substrate 211, and the transition region 222 is with a third atom-aggregation state. In the direction from the first protrusion 221 to the glass substrate 211, the atom-aggregation state of the glass product 200 is from the first atom-aggregation state to the third atom-aggregation state, and finally to the second atom-aggregation state. The bonding density between the atoms gradually decreases from the first protrusion 221 to the glass substrate 211.

A height range of the first protrusion 221 is 1-100 μm. The height of the first protrusion 221 does not include the height of the transition region 222. The first protrusion 221, the transition region 222, and the glass substrate 211 side-by-side constitute the entire glass product 200 together.

The glass product may further include second protrusion, and a distance range between the first protrusion and the second protrusion is 0-1000 μm. The first protrusion is with a first height, and the second protrusion is with a second height.

The arithmetic mean height Sa range of the first height and the second height is 1-30 μm. The difference Sz range between the first height and the second height is 1-50 μm. The quadratic mean height Sq range of the first height and the second height is 1-30 μm.

In some embodiments, the first height is 40 μm and the second height is 10 μm.

In some embodiments, the first height is 30 μm, and the second height is 15 μm.

In step S6, the glass product is taken out.

Specifically, it is sufficient to turn off the laser head 21 and remove the glass product from the fixing device 30.

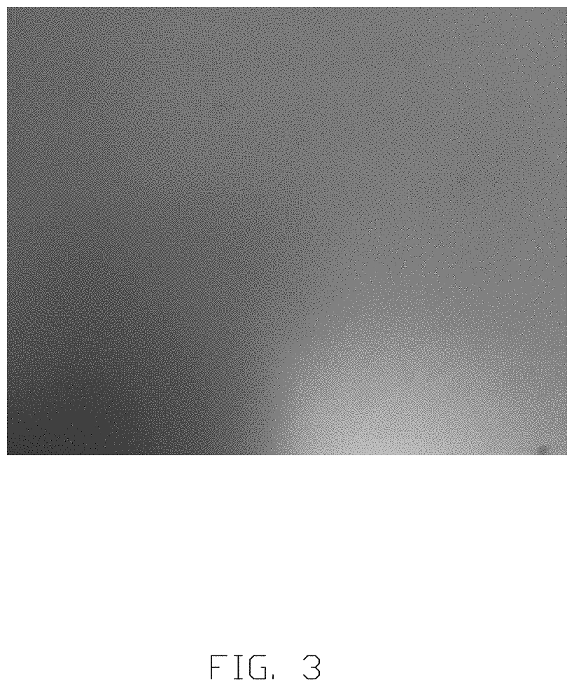

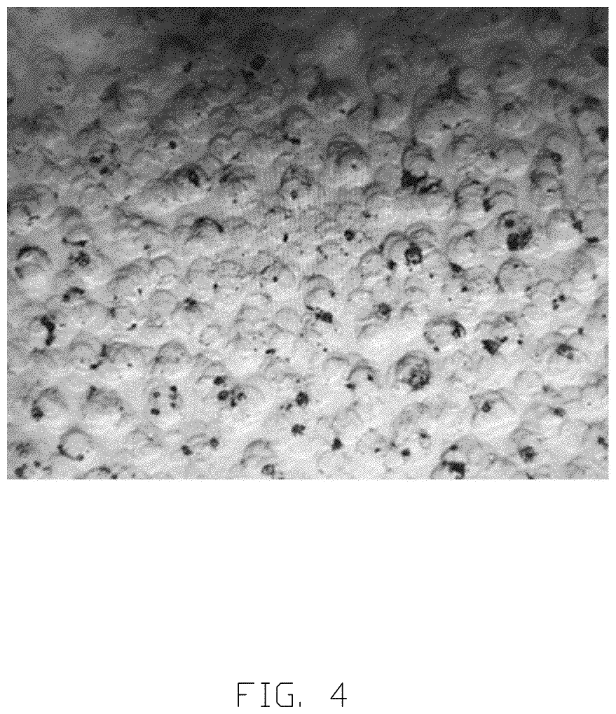

FIGS. 3 and 4 are the photos and microscope photos of the glass products in some embodiments.

Understandably, when the surface cleanliness of the glass substrate is qualified, step S1 may be omitted.

The present application also provides the glass product made by the above preparation method.

The present application also provides the glass product preparation apparatus 100 for manufacturing glass products used in the foregoing manufacturing method.

As the glass product, the preparation method, and the glass product preparation apparatus provided by the present application, by irradiating the surface of the glass substrate with an ultra-short pulse through a pulse laser to break the bond between the atoms on the surface of the glass substrate, thereby changes the arrangement of the atoms and forms the glass product with a low roughness. Diffuse reflection occurs when light irradiates the surface of the glass product, showing an fogging effect. Moreover, the design of the fogging pattern can be performed as required. It can realize rapid fogging, and does not need to directly contact the glass or chemically etch the glass during the production process, which reduces the cost and is with no pollution. Moreover, the glass product after laser fogging can still be processed by traditional fogging.

In addition, those skilled in the art may also make other changes within the spirit of the present application. Of course, these changes based on the spirit of the present application shall be included in the scope of protection claimed in the present application.

What is claimed is:

1. A glass product comprising:
a glass substrate; and
a first protrusion;
wherein the first protrusion is provided on the glass substrate, the first protrusion is with a first atom-aggregation state, the glass substrate is with a second atom-aggregation state, and the first atom-aggregation state and the second atom-aggregation state are different.

2. The glass product according to claim 1, wherein the first atom-aggregation state comprises a first atomic bonding density, the second atom-aggregation state comprises a second atomic bonding density, and the first atomic bonding density is different from the second atomic bonding density.

3. The glass product according to claim 2, wherein the first atomic bonding density is greater than the second atomic bonding density.

4. The glass product according to claim 1, further comprising a transition region, wherein the transition region is provided between the first protrusion and the glass substrate, the transition region is with a third atom-aggregation state; in a direction from the first protrusion to the glass substrate, an atom-aggregation state of the glass product is from the first atom-aggregation state to the third atom-aggregation state, and finally to the second atom-aggregation state.

5. The glass product according to claim 1, wherein a height range of the first protrusion is 1-100 μm.

6. The glass product according to claim 1, further comprising a second protrusion, wherein a distance range between the first protrusion and the second protrusion is 0-1000 μm.

7. The glass product according to claim 6, wherein:
the first protrusion is with a first height, and the second protrusion is with a second height; and
an arithmetic mean height Sa range of the first height and the second height is 1-30 μm.

8. The glass product according to claim 6, wherein:
the first protrusion is with a first height, and the second protrusion is with a second height; and
the difference Sz range between the first height and the second height is 1-50 μm.

9. The glass product according to claim 6, wherein:
the first protrusion is with a first height, and the second protrusion is with a second height; and
the quadratic mean height Sq range of the first height and the second height is 1-30 μm.

10. A method for preparing a glass product, comprising:
fixing a glass substrate;
adjusting a focus depth of a laser, the focus depth comprising a first focus depth and a second focus depth, the laser being a pulse laser;
setting fogging parameters of the laser; and
scanning and irradiating the glass substrate between the first focus depth and the second focus depth with the pulse laser according to the fogging parameters, and to break atomic bonds on a surface of the glass substrate, forming a first protrusion on the glass substrate, the first protrusion being with a first atom-aggregation state, the glass substrate being with a second atom-aggregation state, and the first atom-aggregation state and the second atom-aggregation state being different, thereby forming the glass product.

11. The method according to claim 10, wherein the fogging parameters comprise an optical energy density of the pulse laser, and the optical energy density of the pulse laser is greater than or equal to 1*10¹³ W/cm².

12. The method according to claim 10, wherein the fogging parameters comprise a frequency of the pulse laser, and a frequency range of the pulse laser is 80-200 kHz.

13. The method of claim 10, wherein before the fixing the glass substrate, the method further comprises:
cleaning the glass substrate.

14. A glass product preparation apparatus comprising:
a laser device; and
a fixing device for fixing a glass substrate;
wherein the laser device is used to emit pulse laser, and to adjust a focus depth, the focus depth comprises a first focus depth and a second focus depth, and to set fogging parameters of the pulse laser for scanning and irradiating the glass substrate between the first focus depth and the second focus depth, thereby to break atomic bonds on a surface of the glass substrate, a first protrusion is formed on the glass substrate, the first protrusion is with a first atom-aggregation state, the glass substrate is with a second atom-aggregation state, and the first atom-aggregation state is different from the second atom-aggregation state, thereby forming a glass product.

15. The apparatus of claim 13, wherein the laser device comprises:
a laser head for providing the pulse laser and setting the fogging parameters; and
a focus unit used to focus the pulse laser emitted by the laser head on the glass substrate.

16. The apparatus of claim 13, further comprising a moving device for adjusting a position between the laser device and the glass substrate so that the pulse laser scans and irradiates the glass substrate between the first focus depth and the second focus depth;
wherein the fogging parameters comprise a scanning speed of the pulse laser, and the moving device controls a movement of the laser device to control the scanning speed of the pulse laser.

17. The apparatus of claim 13, further comprising a beam expander used to change a diameter and divergence angle of the pulse laser.
